(19) United States
(12) Patent Application Publication
(10) Pub. No.: US 2008/0136606 A1
(43) Pub. Date: Jun. 12, 2008

(54) SEPARABLE DEVICE FOR CONTROLLING NODE AND SENSOR NETWORK NODE

(75) Inventors: Kee Koo KWON, Daegu (KR); Kyu Hyung KIM, Daegu (KR); Gwang Su KIM, Daejeon (KR); Jang Sik BAE, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/947,527

(22) Filed: Nov. 29, 2007

(30) Foreign Application Priority Data
Dec. 6, 2006 (KR) 10-2006-122862
Jul. 13, 2007 (KR) 10-2007-70332

(51) Int. Cl. G08B 9/00

(52) U.S. Cl. 340/286.02

(57) ABSTRACT

Provided are a separable device for controlling a node and a sensor network node. The separable node-control device includes: a second interface connecting a power line and a data signal line with the outside; and a power supply for supplying power to the second interface and a sensor unit, wherein the power supply and the second interface are controlled by an external control device combined with the second interface and the controller are driven by power supplied from the external device. According to the separable node-control device and the sensor network node, the node-control device is separated from the sensor network node so that the function of the sensor network node can be readily changed according to need.

### CROSS-REFERENCE TO RELATED APPLICATION

This application claims priority to and the benefit of Korean Patent Application No. 2006-122862, filed Dec. 6, 2006, and No. 2007-70332, filed Jul. 13, 2007, the disclosure of which is incorporated herein by reference in its entirety.

### BACKGROUND

1. Field of the Invention

The present invention relates to a separable device for controlling a node and a sensor network node, and more particularly, to a separable node-control device that can be attached to/detached from a sensor node and a sensor network node.

2. Discussion of Related Art

A wireless sensor network consists of sensor nodes and a sink node for a specific purpose. The wireless sensor network refers to a system for transferring information collected from the respective nodes to a management server through an Internet protocol (IP)-based network via a gateway and analyzing the information.

Respective sensor nodes constituting such a sensor network are for collecting information on their respective environments, transferring the collected information, and transferring a signal received from a surrounding sensor node.

However, conventional sensor nodes have a disadvantage in that once a function is set up, it is difficult to change the function.

### SUMMARY OF THE INVENTION

The present invention is directed to a separable device for controlling a node.

The present invention is also directed to enabling separation of a sensor-node control device and thereby facilitating function change of a sensor node according to need.

The present invention is also directed to facilitating function change of a sensor node or a sink node using a Secure Digital (SD) card-type node control device.

One aspect of the present invention provides a separable device for controlling a node, comprising: a first interface connecting a power line and a data signal line with the outside; a transceiver connected to the first interface and communicating with the outside; and a controller connected to the transceiver and the first interface and controlling the transceiver, a second interface, and an external device combined with the first interface, wherein the controller, the transceiver, and the second interface are driven by power supplied from the external device.

The first interface may conform to an SD card standard. The transceiver may communicate with one of a sensor network node and a gateway. In addition, the transceiver may comprise an antenna, and a radio frequency (RF) converter. The controller may be a programmable Micro-Control Unit (MCU).

In addition, the controller may control every type of node included in a sensor network according to an input program. Meanwhile, software of the controller may be changed from an external source. Further, the software of the controller may be changed from an external computing device combined with the second interface. Furthermore, the software of the controller may be changed by a data signal received at the transceiver.

Another aspect of the present invention provides a sensor network node, comprising: a second interface connecting a power line and a data signal line with the outside; and a power supply for supplying power to the second interface and a sensor unit, wherein the power supply and the second interface are controlled by an external control device combined with the second interface.

The second interface may conform to an SD card standard. The external control device may be inserted into the sensor network node.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 conceptually illustrates a sensor network to which the present invention is applied;

FIG. 2 illustrates a sensor network node and a separable device for controlling a node according to exemplary embodiments of the present invention;

FIG. 3 is a block diagram of a sensor network node and a separable node-control device according to exemplary embodiments of the present invention;

FIG. 4 is a block diagram of a Secure Digital Input/Output (SDIO) card type-separable node-control device according to an exemplary embodiment of the present invention; and

FIG. 5 illustrates a sensor network using sensor network nodes to which a separable node-control device according to an exemplary embodiment of the present invention can be attached.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

FIG. 1 conceptually illustrates a sensor network to which the present invention is applied.

Referring to FIG. 1, a sensor network 101 comprises: multiple sensor nodes 111; at least one sink node 113; a gateway 103 for communicating with the sink node 113; and a remote server 115 for analyzing data of the sensor network 101 and controlling the sensor network 101.

The sensor nodes 111 constitute the sensor network 101 and wirelessly communicate with each other. Each of the sensor nodes 111 has a variety of sensor devices according to respective functions, and serves to perceive and transfer a change in its own environment.

The sink node 113 serves to receive sensor data transmitted from the respective sensor nodes 111 and transmit the data to the remote server 115.

Meanwhile, the sink node 113 may have a different physical constitution from the sensor nodes 111. In addition, the sink node 113 may have the same physical constitution as the sensor nodes 111 but a different software constitution from the sensor nodes 111 so that one of the general sensor nodes 111 can be used as the sink node 113. In general, however, the sink node 113 has a different physical constitution from the sensor nodes 111 without a sensor function.

The gateway 103 is a communication device serving to connect the sink node 113 with the remote server 115. Since the energy of a frequency emitted from the sink node 113 may be very low with respect to the size of the sink node 113, a device for receiving a data signal emitted from the sink node 113 and transmitting the signal to the remote server 115 is necessary, which is the gateway 103. The gateway 103 serves not only to amplify a signal generated from the sink node 113 but also to convert the signal of the sink node 113 into a data packet conforming to an Internet protocol (IP) protocol format and transfer the data packet for communication with the remote server 115 belonging to an IP network 105.

The remote server 115 serves to generally manage the sensor network 101, analyze a signal transmitted from the sensor network 101, and generally control operation of the sensor network 101.

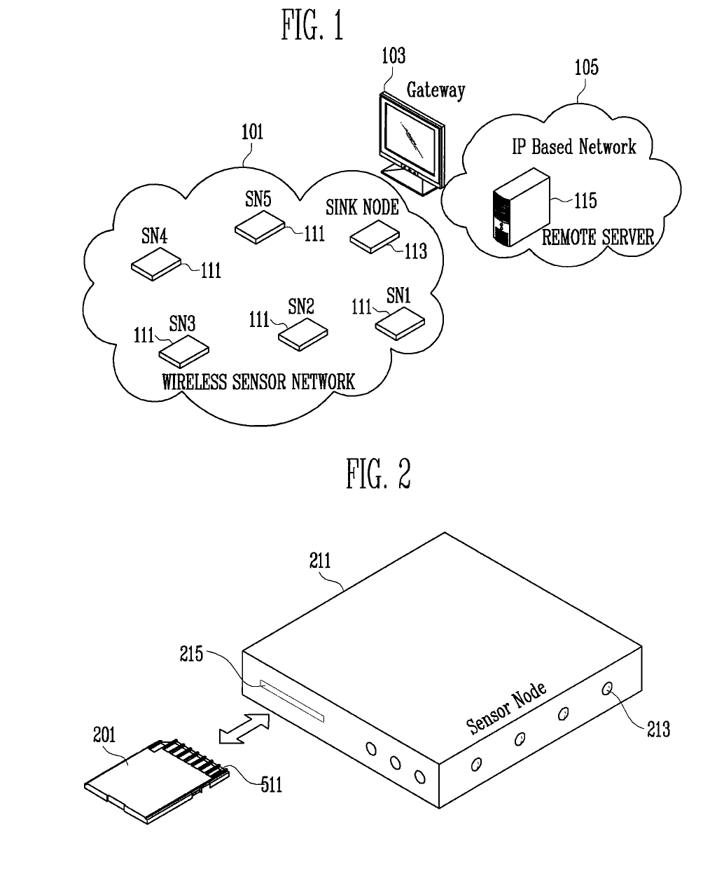

FIG. 2 illustrates a sensor network node and a separable device for controlling a node according to exemplary embodiments of the present invention.

Referring to FIG. 2, the present invention includes a sensor network node 211 and a separable node-control device 201. For convenience of description, the sensor network node 211 includes a sensor unit 213 according to an exemplary embodiment of the present invention.

However, the sensor network node 211 may be any node, such as a sink node and a driver node, constituting a sensor network as well as the sensor node shown in the drawing.

The sensor network node 211 may include the sensor unit 213 that has a sensor, and an interface 215 that can be combined with the separable node-control device 201. However, the present invention can be also applied to a sink node or a driver node not shown in the drawings when the node includes the interface 215 that can be combined with the separable node-control device 201.

The sensor network node 211 includes a power supply to supply separate power, and the sensor unit 213 to serve as a sensor node. On the other hand, the sensor network node 211 does not have a controller to control the sensor network node 211 itself and thus cannot operate by itself.

The separable node-control device 201, which is in the form of a small memory card or a Secure Digital (SD) card, is easily carried and may be attached to/detached from the sensor network node 211 without restriction. The separable node-control device 201 includes a controller capable of controlling the sensor network node 211, a transceiver capable of wirelessly communicating with an external device, and an interface 203 capable of combining with the sensor network node 211. In particular, the controller included in the separable node-control device 201 may be a programmable Micro-Control Unit (MCU) and thus can store a program varying according to the function of the sensor network node 211.

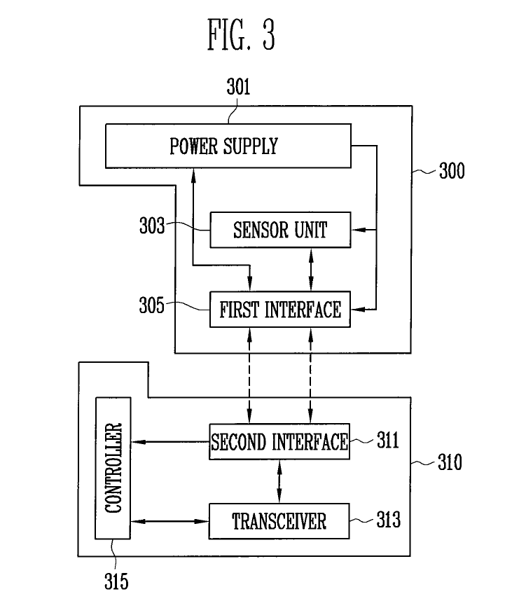

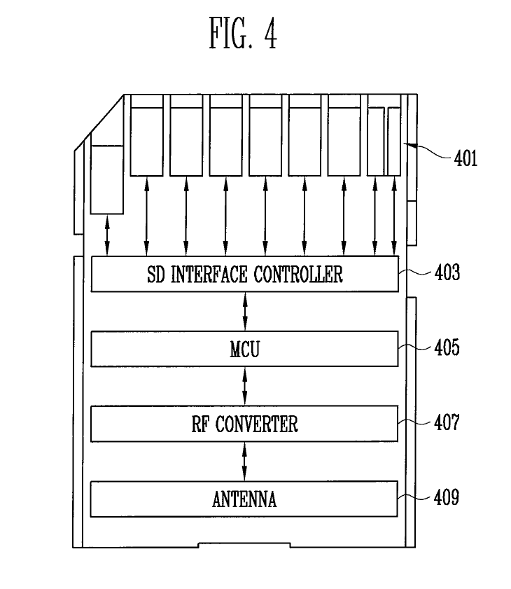

FIG. 3 is a block diagram of a sensor network node and a separable device for controlling a node according to exemplary embodiments of the present invention.

Referring to FIG. 3, a sensor network node 300 according to an exemplary embodiment of the present invention includes a power supply 301, a sensor unit 303, and a first interface 305.

The sensor network node 300 shown in the drawing is a sensor node. When the sensor network node 300 is a sink node, it will not include the sensor unit 303, and when the sensor network node 300 is a driver node, it will include a driver unit instead of the sensor unit 303.

The power supply 301 serves to supply power to all the components of the sensor network node 300 and also to the separable node-control device 310 combining with the first interface 305. In general, a separate power source is used as the power supply 301 so that the sensor network node 300 can independently operate.

The sensor unit 303 is a core part for the sensor network node 300 operating as a sensor node, and serves to perceive a change in the environment of the sensor network node 300 and convert the change into an electrical signal. According to the use or the purpose of a sensor network, the sensor unit 303 may include several sensors for perceiving motion, temperature, vibration, etc., and also may include a plurality of different sensors. In particular, the sensor unit 303 may use only some of included sensors or may not use any of them according to the command of the controller 315 included in the separable node-control device 310.

The first interface 305 combines the sensor network node 300 with the separable node-control device 310. An SD card is frequently used in real life and is an interface that is easy to combine with the simply manufactured and small sized sensor node 300, because the SD card can also be manufactured to be lightweight and small sized. Therefore, the first interface 305 may be formed into an SD Input/Output (SDIO) card. However, unlike a generally used SD card for computer systems, input and output both between the SD card and the sensor network node 300 must be enabled, and thus an SDIO card is required.

The first interface 305 has a power line as well as a sensor signal line to transfer a sensor signal converted at the sensor unit 303 and supply power generated from the power supply 301.

The separable node-control device 310 combined with the sensor network node 300 includes a controller 315, a transceiver 313 and a second interface 311.

The controller 315 serves to control the power supply 301, the sensor unit 303 and the first interface 305 included in the sensor network node 300 combined with the separable node-control device 310 as well as the transceiver 313 and the second interface 311 included in the separable node-control device 310.

The controller 315 serves to analyze and transfer a sensor signal transferred from the sensor unit 303 to the transceiver 313, and transfer a sensor signal of another sensor node received at the transceiver 313 to a sink node. In addition, according to software included in the controller, it is possible to control the sensor node 300 to serve as a sink node or the sensor unit 303 to serve as a specific sensor.

In addition, when the sensor network node 300 is a sink node not including the sensor unit 303 or a driver node including a driver unit, it can perform the corresponding function.

The transceiver 313 serves to convert a sensor signal transferred from the controller 315 into a wireless frequency, transmit the frequency to an external device, and transmit a sensor signal received from an adjacent sensor node to another sensor node. In addition, when the node 300 is a sink node, the transceiver 313 serves to transmit a sensor signal received from a sensor node to a gateway, receive a signal of a remote server from the gateway, and transmit the signal to another sensor node. Furthermore, when the node 300 is a driver node, the transceiver 313 serves to receive a driver signal and provide a signal driving a driver unit according to the driver signal.

The second interface 311 combines with the first interface 305 included in the sensor network node 300, thereby serving to combine the sensor network node 300 with the separable node-control device 310. The second interface 311 must match with the first interface 305.

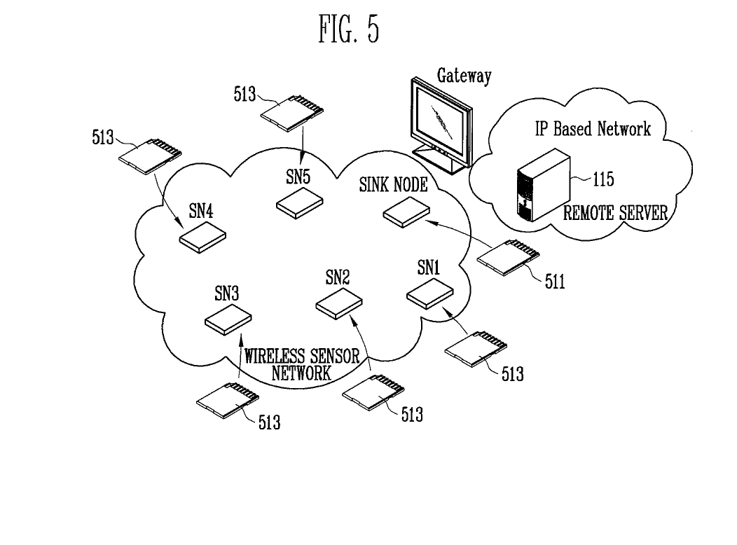

FIG. 4 is a block diagram of an SDIO card type-separable node-control device according to an exemplary embodiment of the present invention.

Referring to FIG. 4, the SDIO card type-separable node-control device includes an SDIO contact unit 401, an SDIO interface controller 403, an MCU 405, a radio frequency (RF) converter 407, and an antenna 409.

The separable node-control device has the form of an SD card and thus can be easily attached to/detached from a sensor node using an SDIO card interface. In addition, it is possible to readily configure or change the program of an MCU using a normal SDIO interface at a portable computing device or a general desktop computer system.

The SDIO contact unit 401 of the SD card type-separable node-control device has 9 contact terminals formed outside according to an SDIO interface. The contact terminals each can transfer all of a data signal, a clock signal, a power signal, and a ground signal.

The SDIO interface controller 403 directly controls the SDIO contact unit 401, and serves to control each pin of each contact terminal of the SDIO contact unit 401 to transfer a signal in a predetermined format.

The MCU 405 is a core part of the node-control device and is a programmable processor. Different programs may be installed in the MCU 405 according to the purpose of controlling a combined sensor node, and thus the sensor node can play a variety of different roles according to situations.

The RF converter 407 serves to convert a signal transferred from the MCU 405 into a wireless frequency so that the antenna 409 can transmit the signal. The RF converter 407 may be constituted in various methods and its size and transmission range may greatly vary according to the constitution. However, the constitution of the RF converter 407 is not closely related to the present invention, and thus a detailed description of the constitution will be omitted.

The antenna 409 serves to transmit the signal converted into the wireless frequency signal at the RF converter 407 to an external device and receive a wireless signal from an external source. The antenna 409 must be appropriately constituted with respect to the size of the separable node-control device according to an exemplary embodiment of the present invention.

FIG. 5 illustrates a sensor network using sensor network nodes to which a separable node-control device according to an exemplary embodiment of the present invention can be attached.

Referring to FIG. 5, a sensor network comprises nodes from which separable node-control devices are detached.

First, one of nodes constituting the sensor network may be determined as a sink node, the sink node may be disposed at an appropriate location, and sensor nodes may be disposed. Then, a gateway is disposed within the reception range of the sink node and is connected to a remote sever through an IP network. Although the sensor network is constituted in this way, it cannot perform a fundamental function unless the node-control devices are attached to the nodes.

Subsequently, a separable node-control device 511 configured to serve as a sink node is inserted into a node to be lastly connected to the gateway, and separable node-control devices 513, in which an appropriate sensor node program for the use of a sensor node is installed, are inserted into other nodes. Then, the sensor network normally operates.

Meanwhile, when the use of the sensor network needs to be changed, it is not necessary to take and re-dispose all the sensor nodes. Rather, the use of the sensor network can be changed by only taking the separable node-control devices combined with the sensor nodes and installing another program in the devices.

When the sensor nodes have hardware constituted to serve as a sink node, it is also possible to change the location of a sink node by only exchanging the separable node-control device 511 with the separable node-control device 513.

According to the present invention, it is possible to provide a separable node-control device.

According to the present invention, a sensor node-control device is separated from a sensor node, and thus it is also possible to easily change a function of the sensor node.

According to the present invention, it is also possible to readily change a function of a sensor node or a sink node using an SD card-type node-control device.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A separable device for controlling a node, comprising:
a first interface connecting a power line and a data signal line with the outside;
a transceiver connected to the first interface and communicating with the outside; and
a controller connected to the transceiver and the first interface and controlling the transceiver, a second interface, and an external device combined with the first interface,
wherein the controller, the transceiver, and the second interface are driven by power supplied from the external device.

2. The separable node-control device of claim 1, wherein the first interface conforms to a Secure Digital (SD) card standard.

3. The separable node-control device of claim 1, wherein the transceiver communicates with one of a sensor network node and a gateway.

4. The separable node-control device of claim 1, wherein the transceiver comprises:
an antenna; and
a radio frequency (RF) converter.

5. The separable node-control device of claim 1, wherein the controller is a programmable Micro-Control Unit (MCU).

6. The separable node-control device of claim 1, wherein the controller controls every type of node included in a sensor network in response to an input program.

7. The separable node-control device of claim 1, wherein software of the controller is able to be changed from an external source.

8. The separable node-control device of claim 7, wherein the software of the controller is able to be changed from an external computing device combined with the second interface.

9. The separable node-control device of claim 7, wherein the software of the controller is able to be changed by a data signal received at the transceiver.

10. A sensor network node, comprising:
a second interface connecting a power line and a data signal line with the outside; and
a power supply for supplying power to the second interface and a sensor unit,
wherein the power supply and the second interface are controlled by an external control device combined with the second interface.

11. The sensor network node of claim 10, wherein the second interface conforms to a Secure Digital (SD) card standard.

12. The sensor network node of claim 10, wherein the external control device is inserted into the sensor network node.
